(19) United States
(12) Patent Application Publication
(10) Pub. No.: US 2008/0094354 A1
(43) Pub. Date: Apr. 24, 2008

(54) Pointing device and method for item location and/or selection assistance

(75) Inventors: Eric Thelen, Aachen (DE); Holger Scholl, Herzogenrath (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/572,280

(22) PCT Filed: Jul. 15, 2005
(86) PCT No.: PCT/IB05/52353

§ 371 Date: Jan. 18, 2007

(30) Foreign Application Priority Data
Jul. 23, 2004 (EP) 04103527.0

(51) Int. Cl. G06F 3/033

(52) U.S. Cl. 345/157

(57) ABSTRACT

The invention describes a pointing device (1) and a methode for item location and/or selection assistance, which method comprises visually presenting a number of items (M1, M2, M3, M4) in a visual presentation (VIP, VP′, aiming a pointing device (1) comprising a camera (2) and a directable source (12) of a concentrated beam of light (L) at the visual presentation (VP, VP′ of the items (M1, M2, M3, M4), generating image data (3) of a target area (A) at which the pointing device (1) is aimed, analysing the image data (3) in order to locate a specific point within the target area (A), generating control signals (9) for controlling the directing arrangement (4), and directing the concentrated beam of light (L) so that the point (P1) coincides with the specific point in the target area (A). The invention describes an interacting device (13) for interacting with a pointing device (1) to carry out I:he method for item location and/or selection assistance. Furthermore, the invention describes a system (14) for item location and/or selection assistance.

This invention relates in general to a pointing device, and, in particular, to a method and system for item location and/or selection assistance using this pointing device.

The use of pointers, such as laser pointers or “wands” incorporating a laser light source to cause a light point to appear on a target at which the pointer is aimed, has become widespread in recent years. Such pointers are essentially passive devices, since they can only be used to point at objects, typically for pointing out items on a screen or projection to members of an audience. DE 299 00 935 U1 suggests a laser pointer with an arrangement of mirrors for directing a point of laser light in a particular direction. Control signals to direct the laser point are issued by a remote device, for example to use the point of laser light to “write” text on a screen. However, this type of pointer is limited to this type of application and is unsuitable, for example, for control of a device.

For convenient and comfortable, if limited, control of devices such as consumer electronics devices, the remote control has become established in recent decades. A remote control, usually held in the hand and pointed at the device to be controlled, e.g. television, DVD player, tuner, etc., is used to select among a number of options, typically by pressing a button, and is typically restricted for use with one, or at most a few such devices. The options available for a device are generally predefined and limited to a certain number, and are displayed on a screen so that the user can study the available options before pressing the appropriate button on the remote control. Generally, a user must spend a considerable amount of time studying the available options and the associated buttons or combinations of buttons on the corresponding remote controls if he is to get properly acquainted with all of his consumer electronics devices. Quite often, the functions of the buttons are not apparent and may confuse the user. Even the manuals or user guides supplied with the device are often unable to clearly explain how a particular function is to be programmed. As a result, the user is often unable to get the most out of the devices he has bought.

The laser pointer and remote control described above are applied, in current state-of-the-art realisations, in a passive one-way type of control. The laser pointer can only be implemented by a user to point something out to an audience, while the remote control can only be used to send predefined control signals to a device. These types of devices, realised as they are, do not in any way exhaust the possibilities of a hand-held device using a pointing modality.

Therefore, an object of the present invention is to provide a convenient pointing device which can be used in an active way and for a broad range of applications.

To this end, the present invention provides a pointing device comprising a camera for generating image data of a target area in the direction in which the pointing device is aimed, a source of a concentrated beam of light for generating a light point within the target area, and a directing arrangement for directing the concentrated beam of light at any point in the target area.

The pointing device according to the invention opens complete new applications for this kind of device. Particularly, with the aid of this device, a user can “locate” or “select” an item or items by simply aiming the pointing device in the general direction of the items. The user can use the pointing device to locate or find an item by allowing the light point of the pointing device to guide him towards the item. On the other hand, selecting an item means that the user can aim the pointing device at a particular item, using the light point as a guide, in order to choose the item or to point it out for some particular purpose. These capabilities of locating and selecting, together with a convenient pointing modality, combine to make the present invention a powerful and practical tool for myriad situations in everyday life.

A method for item location and/or selection assistance according to the invention comprises visually presenting a number of items in a visual presentation, aiming a pointing device comprising a camera and a directable source of a concentrated beam of light at the visual presentation of the items, generating image data of a target area at which the pointing device is aimed, analysing the image data in order to locate a specific point within the target area, generating control signals for controlling the directing arrangement, and directing the concentrated beam of light so that the light point coincides with the specific point in the target area.

The dependent claims and the subsequent description disclose particularly advantageous embodiments and features of the invention.

The items which can be located or selected using the method according to the present invention can be objects such as books, CDs or any type of product, and might be presented or arranged statically, for example on shelves or distributed over a larger area. Equally, the items might be “virtual” items such as options dynamically displayed or presented on a screen or projected onto any suitable type of backdrop. In the following, the terms “item” and “object” may be used interchangeably to mean actual or virtual objects or items, and the term “visual presentation” is used to describe the static or dynamic way in which these actual or virtual objects or items are presented.

The camera for generating images of items in a target area is preferably incorporated in the pointing device but might equally be mounted on the pointing device, and is preferably oriented in such a way that it generates images of the area in front of the pointing device targeted by the user. The camera might be constructed in a basic manner, or it might feature powerful functions such as zoom capability or certain types of filter.

The “target area” is the area in front of the pointing device which can be captured as an image by the camera. The image of the target area—or target area image—might be only a small subset of the entire visual presentation, it might cover the visual presentation in its entirety, or it might also include an area surrounding the visual presentation. The size of the target area image in relation to the entire visual presentation might depend on the size of the visual presentation, the distance between the pointing device and the presentation, and on the capabilities of the camera itself. The user might be positioned so that the pointing device is at some distance from the visual presentation, for example when the user is seated whilst watching television. Equally, the user might hold the pointing device quite close to the visual presentation in order to make a more detailed image.

The image data of the target area might comprise data concerning only significant points of the entire image, e.g. enhanced contours, comers, edges etc., or might be a detailed image with picture quality.

The source of a concentrated beam of light might be a laser light source, such as those used in many types of laser pointers currently available, and is preferably arranged in or on the pointing device in such a way that the concentrated beam of light can be directed at a point within the target area that can be captured by the camera. In the following, it is therefore assumed that the source of a concentrated beam of light is a laser light source, without limiting the scope of the invention in any way.

The directing arrangement for the laser light source might comprise a system of small mirrors which can be moved to reflect the concentrated beam of light in such a way that it is directed in a particular direction. Equally, a number of miniature motors might be used to alter the direction of pointing of the light source. The light point, which appears at the point where the concentrated beam of light impinges on the target area, may thus be directed to appear at any point within the target area, without requiring the pointing device to be moved, thus assisting the user in locating an object. Equally, the light point, which also appears in the image data of the target area, might be used to identify an item selected by the user.

Preferably, an image analysis unit for analysing and interpreting the image data, and a control signal generation unit for generating control signals for controlling the directing arrangement might be incorporated in the pointing device. In this case, the image analysis and control signal generation can take place in the pointing device, and a system for item location and/or selection assistance need therefore comprise only the pointing device itself and a visual presentation of a number of items.

On the other hand, since the capabilities of these units might be limited by the physical dimensions of the pointing device, which is preferably realised to be held comfortably in the hand, such an image analysis unit and control signal generation unit might suffice for rudimentary image analysis and light point control, while more advanced image processing and control signal generation, necessitating larger units, might take place in an external interacting device.

A more powerful system for item location and/or selection assistance therefore comprises the pointing device as well as an interacting device for interacting with the pointing device. The pointing device features a communication interface for transferring or sending the image data to an image analysis unit, as well as a communication interface for receiving from a control signal generation unit the control signals for controlling the directing arrangement. These communication interfaces can be realised separately or may be combined, and might implement known short-distance communication protocols such as Bluetooth or 802.11b standards etc., but might also be capable of long-distance communication using a UMTS, GMS or other mobile telephony standard.

Here, the pointing device might additionally include the means for performing image analysis and control signal generation, while also being able to delegate these tasks to the interaction device. Alternatively, the pointing device might dispense with image analysis and control signal generation, so that these tasks are carried out by the interacting device, allowing the pointing device to be realised in a smaller, more compact form.

An interacting device for interacting with such a pointing device might be incorporated into an already existing home entertainment device, a personal computer, or might be realised as a dedicated interacting device. To communicate with the pointing device, the interacting device features a receiving unit for receiving image data from the pointing device and a sending unit for sending the control signals to the pointing device. Image analysis and control signal generation take place in an image analysis unit and control signal generation unit respectively.

A preferred realisation of the interacting device might feature a speech interface, so that the user can make his wishes known by speaking them. For example, he might say “Show me how to set the date on the video recorder”, and, after interpreting his words and the image data from the camera of the pointing device, the interacting device can send the correct sequence of control signals for the directing arrangement so that the light point is moved in a particular way, demonstrating to the user the correct sequence of moves and option selections. Such a speech interface may also be incorporated in the pointing device, or the pointing device might comprise a microphone and loudspeaker and be able to transmit and receive speech data to and from the interacting device for further processing.

The interaction device might be realised as a dedicated device as described, for example, in DE 102 49 060 A1, constructed in such a way that a moveable part with schematic facial features can turn to face the user, giving the impression that the device is listening to the user. Such an interaction device might even be constructed in such a fashion that it can accompany the user as he moves from room to room, so that the use of the pointing device is not restricted to one area. The interaction device might be able to control any number of applications or devices such as home entertainment devices, a shopping list application, and managing collections of items such as CDs or books.

To easily determine the item at which the user is aiming the pointing device, the image analysis unit preferably compares the received image data of the target area to a number of pre-defined templates. A single pre-defined template might suffice for the comparison, or it may be necessary to compare the image data to more than one template.

Pre-defined templates can be stored in an internal memory of the pointing device or the interacting device, or might equally be accessed from an external source. Preferably, the interacting unit, and/or the pointing device itself, comprises an accessing unit with an appropriate interface for obtaining pre-defined templates for the visual presentations from, for example, an internal or external memory, a memory stick, an intranet or the internet. A template can be a graphic representation of any kind of visual presentation, such as an image of a bookshelf, a store-cupboard, a display etc. A template might show the positions of a number of predefined menu options for a television, so that, by analysing image data of the target area when the user aims the pointing device at the television, the image analysis unit can determine which option is being selected by the user, or the position to which the light point should be directed in order to show the user a particular option.

As already mentioned above, the user of the system may wish to select an item from among a collection of items, or may require assistance in finding or locating an object from among a number of objects. The items or objects might be actual items, or might be virtual items such as options available for an application or device.

The user might select items or point out items using the pointing device, for example, in order to train the system to identify books in a collection by remembering their positions or recognising their appearance. To this end, the user might initiate the training process in some way, for example by saying something like “These are books in my library”, and proceeding to point at each book in turn, whilst saying the title of each book (in a more advanced realisation, the image analysis unit might “read” the titles of the books itself using appropriate image processing techniques). The user might indicate each particular book by moving the pointing device in a predefined manner, for example by moving it so that the light point describes a circle around the book being named. While in this mode of training the system to recognise items, the light point is preferably fixed, for example in the centre of the target area, so that the user can easily see where exactly he is aiming the pointing device. If the pointing device features a button, the user might press the button after naming the book to confirm his selection.

To simplify locating items in a collection at a later point in time, the user might make use of the pointing device to create a template of the area in which a particular collection is stored. For example, the template for a collection of books might be the shelves on which they are stored. The user might indicate that a template is to be created by speaking a suitable command or by pressing a button on the pointing device. He might then move the pointing device by panning it over the area occupied by the bookshelf. When done, he might indicate in some manner, for example by saying “Finished”, or by pressing or releasing a button on the pointing device. The image analysis unit can then analyse the images to construct a template. This template can be used later on when the user is training the system to remember the locations of the books, so that the system can associate each item with a particular location in the template.

The system can then be used to provide assistance in finding an item or object. When searching for an item, the user can inform the interacting device of his wishes and aim the pointing device at a suitable visual presentation.

The system can also be used to locate actual items in a collection. For example, the user might say “I can't remember where the book ‘Dealing with Forgetfulness’ is kept”, and aim the pointing device at the appropriate bookshelf. Using a template of this bookshelf and its contents, generated previously as described above, the interaction device locates the desired book in the template. Using the image data of the target area, it calculates the position of the target point relative to the desired point, and generates control signals to direct the light point towards this desired point. If the book is outside of the target area aimed at by the pointing device, the control signals might cause the light point to appear to “bounce” against the edge of the target area closest to the desired point, indicating to the user that he must move the pointing device in that direction in order to be able to locate the desired object. Image data are continually analysed as the user moves the pointing device. Once the desired point is identified in the image data, the light point might be positioned so that it appears to be directly on the object, or it might appear to describe a tight circle about the object, thus showing the user where the object is located. In this example, the desired object was found by comparing its position or coordinates, previously stored in a template, with the coordinates of the target point of the image data. Once the coordinates of the desired object sufficiently match the coordinates of the target point, the system concludes that the desired object has been located. A suitably advanced system might even be able to help the user locate items over a wider range, so that, in the example above, the user need not point the device at the bookshelf, but might even be in a different room. The system then directs the user with the light point in the direction of the right room and towards the bookshelf.

An alternative way of locating objects might be to use image processing techniques to identify the image of the object in the image data of the target area. This would allow for the realistic possibility of items being removed from a collection and being returned to a different position in the collection. In this case, the system records images of the objects which it is trained to recognise, for example it might record an image of the spine of a book when being trained to recognise books, or it might record an image of the barcode of a product when being trained to manage a shopping list.

In another preferred application, the pointing device might be used in a museum or library setting to locate items of interest. For example, a visitor to a museum might be supplied with a pointing device which is able to interact with the museum's own interactive system for item location, where the items in this case might be the museum exhibits or particular areas of the museum such as shops, restaurants or rest-rooms, or particular objects within these areas. The visitor to the museum might also be supplied with a headset through which he can issue requests to the museum's interactive system, for example he might ask to be directed to a particular exhibit. The visitor need only aim the pointing device more or less in front of him so that he can see the light point generated by the laser light source. The museum's interacting device can then guide the light point of the pointing device by means of appropriate control signals in the direction of the desired exhibit. By continually tracking the position of the visitor with respect to the desired exhibit, for example by analysing the images of the target areas which are sent at intervals to the interacting device, the interacting device can decide when the desired exhibit has been reached, and can indicate this to the visitor by moving the light point in a particular manner, for example by appearing to describe a loop, circle or other pattern about the exhibit. The museum's interacting device might offer the user descriptions of an exhibit, whilst directing the light point over the exhibit to point out the area currently being described.

In a supermarket or department store setting, the user might scan a written shopping list with his pointing device, which in turn initiates communication with the supermarket or department store's own interactive system to locate the items on the list. The user need only aim the pointing device in the general direction of the shelves, and will be guided by the light point to the desired items, one after another. This will be particularly advantageous when the user is shopping in a supermarket or department store with which he is not familiar, since using the pointing device to locate the desired items will save time and spare the user the inconvenience of having to search for them himself. As an alternative to using a shopping list, the user might have previously recorded images or descriptions of his favourite store-cupboard products with the pointing device, which, on entry to the supermarket, transfers this information to an interaction device of the supermarket, which responds by sending appropriate control signals to the pointing device. The light point of the pointing device can subsequently direct the user to the relevant locations in the supermarket.

In another application of the system, a home entertainment device might offer a tutorial mode to help the user become acquainted with its functions. Such a home entertainment device, e.g. a video recorder, might be controlled or driven by a stand-alone interacting device, or might incorporate an interacting device. The tutorial mode might be initiated by the user, for example by saying “How do I program the VCR to record?”, or by the device itself when it deduces that the user is having problems programming the device. In tutorial mode, the interacting device might send control signals to the pointing device, guiding the light point to the relevant options displayed in the usual manner on the television screen to show the user which options to select and in which sequence to select them.

The movement of the pointing device relative to the visual presentation might preferably be detected by image processing software in the image analysis unit. Alternatively or in addition to this, motion might be detected by a motion sensor in the pointing device. A positioning system such as GPS might be used to determine position information when the user of the pointing device roams over larger areas.

For processing the image data in order to determine the item at which the user is aiming the pointing device, it is expedient to apply computer vision techniques to find a point in the visual presentation at which the user has aimed, i.e. the target point.

In one embodiment of the invention, a fixed point in the target area image, preferably the centre of the target area image, obtained by extending an imaginary line in the direction of the longitudinal axis of the pointing device to the visual presentation, might be used as the target point. When using the pointing device to select objects, the light point is preferably fixed to point, for example, at the centre of the target area. This user might indicate by means of a button on the pointing device that the pointing device is to be used in a selection mode.

A method of processing the target area images of the visual presentation using computer vision algorithms might comprise detecting distinctive points in the target image and determining corresponding points in the template of the visual presentation, and developing a transformation for mapping the points in the target image to the corresponding points in the template. The distinctive points of the target area image might be distinctive points of the visual presentation, or might equally be points in the area surrounding the visual presentation, for example the corners of a television screen or bookshelf. This transformation can then be used to determine the position and aspect of the pointing device relative to the visual presentation so that the intersection point of an axis of the pointing device with the visual presentation can be located in the template. The position of this intersection in the template corresponds to the target point on the visual presentation, and can be used to easily determine which of the items has been targeted by the user. The position of the target point in the pre-defined template indicates, for example, an option selected by the user. In this way, comparing the target area image with the pre-defined template is restricted to identifying and comparing only salient points such as distinctive corner points. The term “comparing” as applicable in this invention is to be understood in a broad sense, i.e. by only comparing sufficient features in order to quickly identify the point at which the user is aiming.

Another possible way of determining an item selected by the user is to directly compare the received target area image, centred around the target point, with a pre-defined template to locate the point targeted in the visual presentation using methods such as pattern-matching. Another way of comparing the target area image with the pre-defined template might restrict itself to identifying and comparing only salient points such as distinctive corner points.

In a further embodiment of the invention, the location of the laser point, fixed at a certain position in the target area and transmitted to the receiver in the control unit as part of the target area image, might be used as the target point to locate the option selected by the user. The laser point may coincide with the centre of the target area image, but might equally well be offset from the centre of the target area image.

The invention thus provides, in all, an easy and flexible way to locate and/or select items. For ease of use, the pointing device can be in the shape of a wand or pen in an elongated form that can be grasped comfortably by the user. The user can thus direct the pointing device at a target point in the visual presentation while positioned at a comfortable viewing distance from it. Equally, the pointing device might be shaped in the form of a pistol. Furthermore, an additional light source might be mounted in or on the pointing device, serving to illuminate the area at which the pointing device is aimed, so that the user can easily peruse the visual presentation, even if the surroundings are dark.

Other objects and features of the present invention will become apparent from the following detailed descriptions considered in conjunction with the accompanying drawing. It is to be understood, however, that the drawings are designed solely for the purposes of illustration and not as a definition of the limits of the invention.

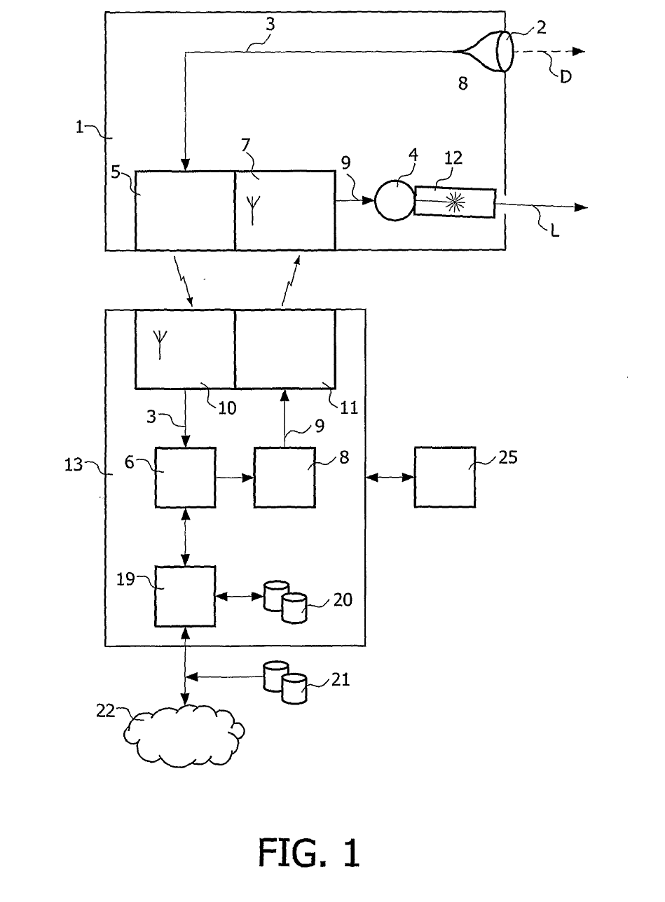

FIG. 1 is a schematic diagram of a pointing device and an interacting device in accordance with an embodiment of the present invention;

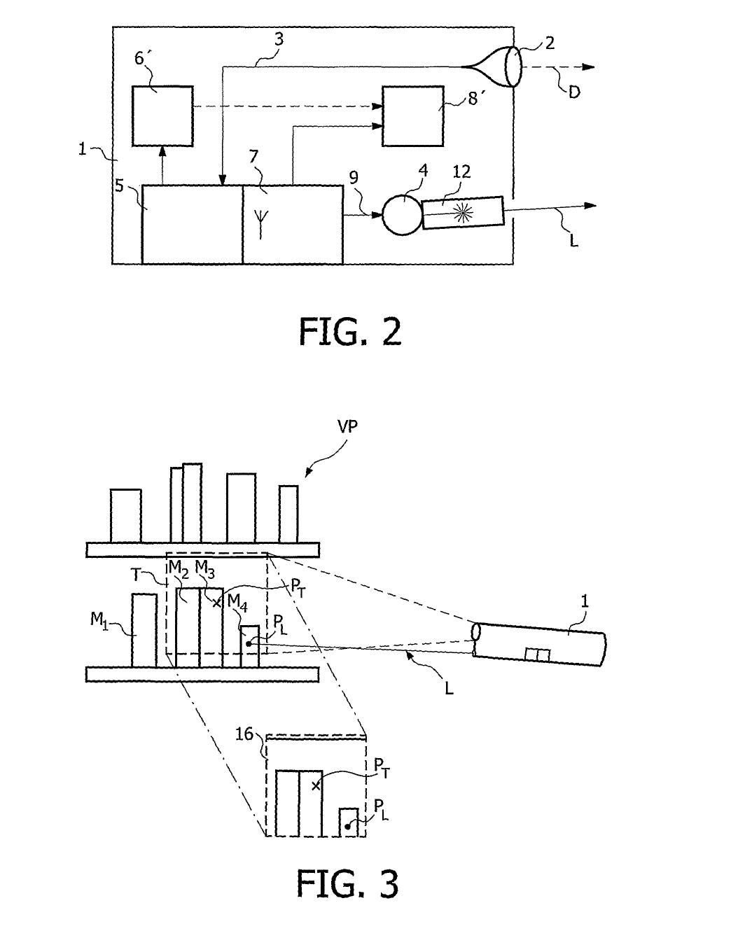

FIG. 2 is a schematic diagram of a pointing device in accordance with an embodiment of the present invention;

FIG. 3 is a schematic diagram of a visual presentation of a collection of items and a target area image of the visual presentation made by a pointing device, in accordance with an embodiment of the present invention;

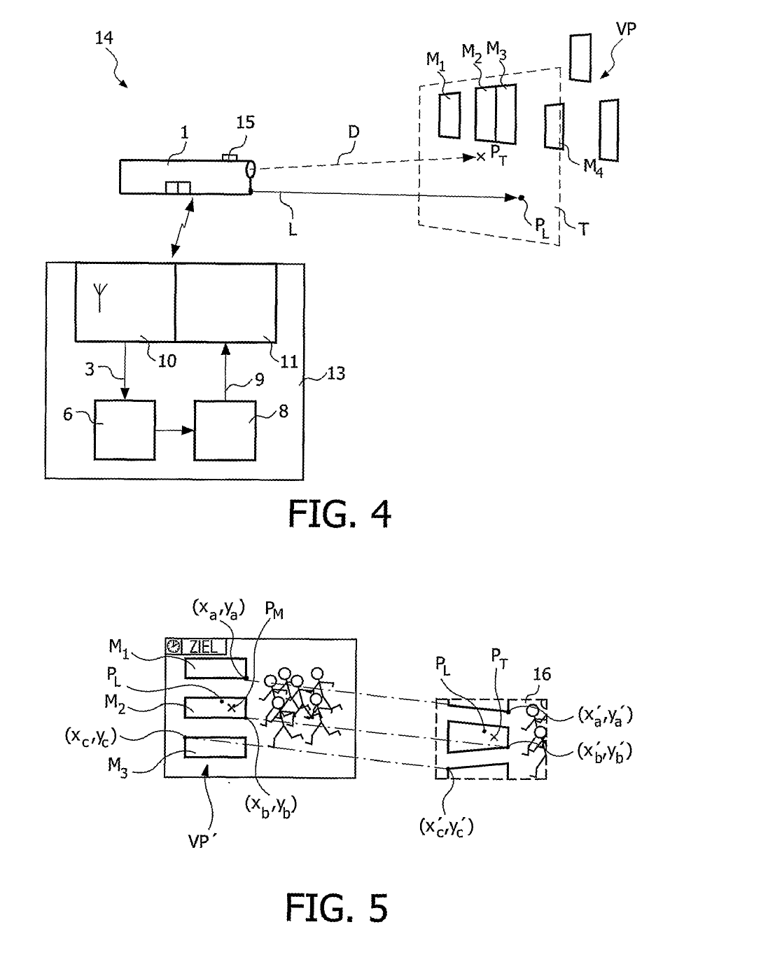

FIG. 4 is a schematic diagram of a system for locating or selecting an item amongst a collection of items, in accordance with an embodiment of the present invention.

FIG. 5 is a schematic diagram showing a visual presentation and a corresponding target area image in accordance with an embodiment of the present invention.

In the drawings, like numbers refer to like objects throughout. The pointing device described is held and operated by a user, not shown in the drawings. The user can communicate by means of a suitable user interface, also not shown in the drawings, with the device for interacting with the pointing device.

FIG. 1 shows a pointing device 1 containing a camera 2 which generates images of the area in front of the pointing device 2 in the direction of pointing D. The pointing device 1 features an elongated form in this embodiment, so that the direction of pointing D lies along the longitudinal axis of the pointing device 1. The camera 2 is positioned towards the front of the pointing device 1 so that images are generated of the area in front of the pointing device 2 at which the user 8 is aiming. Image data 3 describing the images are transmitted by means of a communication interface 5 enclosed in the housing of the pointing device 1, and are transmitted in a wireless manner, e.g. Bluetooth, 802.11b or mobile telephony standards, to an interacting device 13. A receiving unit 10 in an interacting device 13, working together with the pointing device 1, receives the image data 3 and forwards them to an image analysis unit 6.

The received image data 3 are analysed in the image analysis unit 6 of the interacting device 13, where they are compared to other images or templates retrieved from an internal memory 20 or an external source 21, 22 by an accessing unit 19. Ideally, the accessing unit 19 has a number of interfaces allowing access to external data, for example the user might provide pre-defined templates stored on a memory medium 21 such as floppy disk, CD or DVD, or the accessing unit 19 might retrieve suitable template information from an external network such as the internet 22. The templates may also be configured by the user, for example in a training session in which the user specifies the correlation between specific areas on a template with particular items or functions.

The user in this case may be trying to locate an item, so that the image analysis unit 6 compares the image data 3 with the templates to determine whether the item sought is within the target area or not, and directs a control signal generator 8 to generate appropriate control signals 9, which are transmitted by a sending unit 11 of the interacting device 13 in a wireless manner to a communication interface 7 of the pointing device 1.

A laser light source 12, incorporated in the pointing device 1, emits a beam of laser light L in a direction not necessarily parallel to the direction of pointing D. The actual direction of the beam of laser light L is controlled by a directing arrangement 4 which applies the received control signals 9 to adjust the direction of pointing of the laser light source 12. The light point is directed in such a way that the user is eventually guided to the item being sought. In the figure, the directing arrangement 4 applies the control signals 9 to alter the position of the laser light source 12 accordingly, by means of, for example, a miniature motor. The beam of laser light L is thus aimed in the desired direction. In an alternative realisation, the directing arrangement 4 may comprise a number of small mirrors, whose position can be altered, and arranged in such a way that the mirrors deflect the beam of laser light L in the required direction. It is also feasible that a combination of miniature motor and mirrors might be used to control the direction of the beam of laser light L.

In another scenario, the pointing device 1 is being used to select an item, for example when training the interacting device to recognise and locate items. In this case, image data 3 is generated by aiming the pointing device at the item to be recognised, and is sent to the image analysis unit 6 to be analysed and processed in some way before being stored in a suitable format in the internal or external memories 20, 21.

In another application, the interacting device 13 features an interface 24 for communicating with an external device 25 such as a television, VCR, or any type of device with which a dialog might be initiated. Here, the interacting device 13 informs the external device 25 in some way of the user's actions. For example, the image analysis unit 6 determines, with the aid of templates for the options of this device 25, the area in the template at which the user is pointing, and sends this information to the external device 25, which interprets the information and send appropriate signals to the interacting device, where they are converted to control signals 9 for the directing arrangement 4 of the pointing device 1. In this way, the pointing device 1 together with the interacting device 13 can be used to assist the user in controlling or communicating with external devices 25.

FIG. 2 shows an embodiment of the pointing device 1 featuring its own image analysis unit 6′ and control signal generator 8′. This pointing device 1 can analyse image data 3 generated by its camera 2 to locally generate control signals 9 for the directing arrangement 4. Being able to perform the image processing locally means the pointing device 1 does not necessarily need to communicate with a separate interacting device 13 as described in FIG. 1. Since the quality of the image analysis might be limited by the physical dimensions of the pointing device 1, which will most likely be realised in a small and practical format, this “stand-alone” embodiment might suffice for situations in which the accuracy of the image analysis is not particularly important, or in situations where the pointing device 1 is unable to communicate with an interacting device. This embodiment may of course be simply an extension of FIG. 1, so that the pointing device 1 also avails of the communication interfaces 5, 7 described in FIG. 1, allowing it to operate in conjunction with an interacting device 13 such as a dialog system in addition to its stand-alone functionality. This embodiment might also features a local memory, not shown in the diagram, in which the pointing device 1 can store images generated by the camera 2.

FIG. 3 shows a visual presentation VP, in this case a number of actual objects M₁, M₂, M₃, M₄ on a shelf. A pointing device 1 is being aimed at a target area T of this visual presentation VP to select or locate one of the objects M₁, M₂, M₃, M₄.

If the user wants to locate an object, for example the item M₄, he might request an interacting device (not shown in the drawing) to assist him in locating it. Images 16 of the target area T are transmitted at intervals to the interacting system, where they are analysed to determine the area at which the pointing device 1 is aimed, and whether this area contains the item M₄ being sought. As long as this item M₄ cannot be detected in the image 16 of the target area T, the light source 12 of the pointing device 1 is directed by means of control signals so that the ensuing light point PL is moved in such a way as to indicate to the user the direction in which he must aim the pointing device 1 so that the item M₄ can ultimately be detected in the image 16 of the target area T, at which stage the light point PL is positioned over the desired item M₄ to show the user where it is. In the event that the system cannot locate an item because the item is missing or because the system is unable to understand the user's wishes, the light point PL might behave in a predefined manner e.g. by being turned on and off in a particular sequence, or by describing a predefined pattern. This would be of use, when, for example, the interacting device is unable to communicate with user by means of speech.

Should the user wish to select one of the items M₁, M₂, M₃, M₄ visible in the visual presentation VP, for example when training the interacting device to remember the locations of objects or to recognise their appearance, the user can aim the pointing device 1 at the visual presentation VP so that the object in question is indicated by the light point P_{L}. When the pointing device is being used in such a training mode, the light point P_{L} can maintain a fixed position relative to the centre of the target area A, given by P_{T}. The light point P_{L} might be directed at a fixed position at a point removed from the centre point P_{T} or it might coincide with the centre point P_{T}.

With the aid of the light point P_{L}, the user can select one of the items M₁, M₂, M₃, M₄ shown in the visual presentation VP. A camera in the pointing device generates an image of the target area T centred around an image centre point P_{T}. The light point P_{L} also appears in the target area image. In this example, the light point P_{L} appears at a very small distance away from the image centre point P_{T}, so that the user can use the light point P_{L} to accurately point out items to the interacting device, in this case the item M₃. The user then describes the object M₃ for the interacting device, for example by saying “This book is ‘Middlemarch’ by George Eliot”, so that the interacting device performs any necessary image processing before storing the information describing the item M₃ to memory.

FIG. 4 shows a pointing device 1, an interacting device 13 and a visual presentation VP giving a system 14 for item location and/or selection assistance.

The interacting device 13 is in this example might be incorporated in some kind of home dialog system, allowing the user to communicate with it by means of spoken commands. For example, the user has asked the interacting device 13 a question, such as “Where is my Dire Straits CD ‘Money for Nothing’?”. The user aims the pointing device 1 in the general direction of the shelves on which his CD collection is kept, and allows the interacting device 13, in conjunction with the pointing device 1, to show him where the requested CD is kept. The interacting device 13, which has been trained in a previous training session to remember the locations of all the CDs in the collection, now sends control signals to the directing arrangement of the pointing device 1 so that the light point P_{L} is directed at the requested CD. If the requested CD is located within the target area T, the light point comes to rest on this CD, or might be caused to describe a tight circle over the CD. However, if the CD is outside of the target area T, the control signals issued by the interacting device 13 cause the light point P_{L} to repeatedly move against the appropriate edge of the target area T, so that the user will realise that he must move the pointing device 1 in the indicated direction until the target area T includes the requested CD.

In this embodiment, the pointing device 1 also features a button 15. The button 15 can be pressed by the user, for example to confirm that he has made a selection and to record the image of the target area.

Alternatively or additionally, such a button 15 might be used to activate or deactivate displaying of a dynamic visual presentation VP′ on, for example, a television screen, so that items or options are only displayed on the screen when actually required by the user. Alternatively, the function of the button 15 or a different button on the pointing device 1 might be to activate or deactivate the light source 12 incorporated in the pointing device 1, to activate or deactivate the pointing device 1 itself, or to switch between “locate” and “select” modes of operation. The pointing device 1 might be activated by means of a motion sensor incorporated in the pointing device 1, so that the laser light source is activated when the user takes hold of the pointing device 1, and that the pointing device starts to send images of the target area to the interacting device as soon as it the pointing device is taken up or moved.

The pointing device 1 draws its power from one or more batteries, not shown in the figure. Depending on the consumption of the pointing device 1, it may be necessary to provide a cradle into which the pointing device 1 can be placed when not in use, to recharge the batteries.

The user will not always aim the pointing device at right angles to the visual presentation—it is more likely that the pointing device will be aimed at a more or less oblique angle to the visual presentation, since it is easier to wave the pointing device that it is to change one's own position. This is illustrated in FIG. 5, which shows a schematic representation of a target area image 16 generated by a pointing device, not shown in the diagram, which is aimed at the visual presentation VP′ from a distance and at an oblique angle, so that the scale and perspective of the items M₁, M₂, M₃ in the visual presentation VP′ appear distorted in the target area image 16. In the case shown in FIG. 5, the visual presentation VP′ is a television screen and the items M₁, M₂, M₃ from among which the user can choose at are menu items displayed on the screen.

Regardless of the angle of the pointing device 1 with respect to the visual presentation VP′, the target area image 16 is always centred around an target point P_{T}. The laser point P_{L} also appears in the target area image 16, and may be a distance removed from the target point P_{T}, or might coincide with the target point P_{T}. The image processing unit of the dialog system compares the target area image 16 with pre-defined templates to determine the item being pointed at the user, or to determine the location of the target point relative to the location of an item which the user is trying to locate.

To this end, the point of intersection P_{T} of the longitudinal axis of the pointing device 1 with the visual presentation VP′ is located. The point in the template corresponding to the point of intersection P_{T} can then be located. Computer vision algorithms using edge- and corner detection methods are applied to locate points in the target area image [(xₐ, yₐ), (x_{b}, y_{b}), (x_{c}, y_{c})] which correspond to points in the template [(xₐ′, yₐ′), (x_{b}′, y_{b}′), (x_{c}′, y_{c}′)] of the visual presentation VP′.

Each point can be expressed as a vector e.g. the point (xₐ, yₐ) can be expressed as \vec{v}ₐ. As a next step, a transformation function T_{λ} is developed to map the target area image to the template:

$$f ( λ ) = {\sum }_{i} {\vert {T}_{λ} ( {\vec{v}}_{i} ) - {\vec{v}}_{i}^{′} \vert}^{2}$$

where the vector \vec{v}ᵢ represents the coordinate pair (xᵢ, yᵢ) in the target area image, and the vector \vec{v}ᵢ′ represents the corresponding coordinate pair (x′ᵢ, y′ᵢ) in the template. The parameter set λ, comprising parameters for rotation and translation of the image yielding the most cost-effective solution to the function, can be applied to determine the position and orientation of the pointing device 1 with respect to the visual presentation VP. The computer vision algorithms make use of the fact that the camera 2 within the pointing device 1 is fixed and “looking” in the direction of the pointing gesture. The next step is to calculate the point of intersection of the longitudinal axis of the pointing device 1 in the direction of pointing D with the plane of the visual presentation VP. This point may be taken to be the centre of the target area image P_{T}. Once the coordinates of the point of intersection have been calculated, it is a simple matter to locate this point in the template of the visual presentation VP.

Although the present invention has been disclosed in the form of preferred embodiments and variations thereon, it will be understood that numerous additional modifications and variations could be made thereto without departing from the scope of the invention. The pointing device can serve as the universal user interface device in the home or for navigation through business presentations. Outside of the home, it can be used in any environment where the user can be guided by means of the light point. In short, it can be beneficial wherever the user can express an intention by pointing, or wherever something can be actively pointed out to the user. Its small form factor and its convenient and intuitive usage can elevate such a simple pointing device to a powerful universal remote control or teaching tool. As an alternative to the pen shape, the pointing device could for example also be a personal digital assistant (PDA) with a built-in camera, or a mobile phone with a built-in camera. The pointing device might be combined with other traditional remote control features, e.g. with additional buttons for performing dedicated functions, or with other input modalities such as voice control.

For the sake of clarity, it is also to be understood that the use of “a” or “an” throughout this application does not exclude a plurality, and “comprising” does not exclude other steps or elements. A “unit” may comprise a number of blocks or devices, unless explicitly described as a single entity.

1. A pointing device, comprising
a camera for generating image data of a target area in the direction in which the pointing device is aimed;
a source of a concentrated beam of light for generating a light point within the target area; and
a directing arrangement for directing the concentrated beam of light at any point in the target area .

2. A pointing device (1) according to claim 1, comprising
a communication interface for transferring image data to an image analysis unit; and
a communication interface for receiving from a control signal generation unit control signals for controlling the directing arrangement.

3. A pointing device according to claim 1, further comprising
an image analysis unit for analysing image data; and
a control signal generation unit for generating control signals for controlling the directing arrangement.

4. An interacting device or interacting with a pointing device according to claim 2, comprising
a receiving unit for receiving image data from the pointing device;
an image analysis unit for analysing the received image data;
a control signal generation unit for generating control signals for controlling the directing arrangement of the pointing device;
a sending unit for sending the control signals to the pointing device;

5. A system for item location and/or selection assistance comprising a pointing device according to claim 3, and a visual presentation of a number of items.

6. (canceled)

7. A method for item location and/or selection assistance, comprising:
visually presenting a number of items in a visual presentation;
aiming a pointing device comprising a camera and a directable source of a concentrated beam of light at the visual presentation of the items;
generating image data of a target area at which the pointing device is aimed;
analysing the image data in order to locate a specific point within the target area;
generating control signals for controlling the directing arrangement; and
directing the concentrated beam of light so that the light point coincides with the specific point in the target area.

8. A method according to claim 7, where a visual presentation of the items is presented in static form.

9. A method according to claim 7, where a visual presentation of the items is presented dynamically.

10. A method according to claim 7, wherein image data of the target area are analysed by comparing it to a predefined template of the target area and/or the visual presentation.

11. A method according to claim 7, where a located item is shown to the user by directing the light point at the located item.

12. A method according to claim 7, where a selected item is determined by locating a point in the template corresponding to a target point in the visual presentation at which a user has aimed the pointing device.

13. A method of according to claim 12, where the target point is determined by a method comprising the following steps: detecting distinctive points in the image data of the visual presentation;
determining corresponding points in the template of the visual presentation;
developing a transformation for mapping the points in the image data to the corresponding points in the template;
using the transformation to determine the position and aspect of the pointing device relative to the visual presentation;
locating the intersection point of a certain axis of the pointing device with the visual presentation.
